(19) United States
(12) Patent Application Publication
(10) Pub. No.: US 2013/0166381 A1
(43) Pub. Date: Jun. 27, 2013

(54) ADVERTISEMENT DISPLAY UI AND ADVERTISEMENT SYSTEM

(71) Applicant: Shigeto Umeda, Palo Alto, CA (US)

(72) Inventor: Shigeto Umeda, Palo Alto, CA (US)

(73) Assignee: Dennco Inc., Palo Alto, CA (US)

(21) Appl. No.: 13/698,037

(22) PCT Filed: May 16, 2011
(86) PCT No.: PCT/JP2011/061703

§ 371 Date: Feb. 28, 2013

(30) Foreign Application Priority Data
May 14, 2010 (JP) 2010-112114
Jul. 27, 2010 (JP) 2010-168467
Oct. 16, 2010 (JP) 2010-233148

(51) Int. Cl. G06Q 30/02

(52) U.S. Cl. CPC G06Q 30/0255
USPC 705/14.53; 705/14.73; 705/14.58

(57) ABSTRACT

Disclosed is an effective and high-quality advertisement information display system that adapts to an internet user's lifestyle. The disclosed advertisement system includes a user interface such as an internet browser that itself has the capability of acquiring and displaying video advertisement data, at least one advertisement data storage site located on a communication network, and a user terminal connected to the abovementioned communication network and provided with the abovementioned browser, and by means of the abovementioned advertisement display capability, the advertisement system displays video advertisement data obtained by the user interface's advertisement acquisition capability to a user in accordance with an advertisement management capability. In the system, the user interface has a social capability, and users can gain rewards according to advertisements browsed.

### FIELD OF THE INVENTION

The present invention relates to UI (user interface) that itself has the capability of acquiring and displaying advertisement data and an advertisement system using the same, and particularly to a socialized advertisement display UI and an advertisement system using the same. As used herein, the term “UI” refers to a visual means that provides an information and/or capability operating means at various types of platforms and includes displays on the operating screens of applications, internet browsers (hereinafter referred to as “web browsers” or simply “browsers” and which are tools used for connecting to the Internet from OS or OS itself as the case may be), digital signage, electronic monitors, smart phones, portable terminals, car navigation systems, tablets, etc. Accordingly, as used herein, the term “UI (user interface)” has the concept covering areas of general software that can be recognized by users including OS itself and, therefore, has a wider concept than that of ordinary UI (user interface).

### BACKGROUND OF THE INVENTION

The Internet advertisement market has recently grown rapidly and is expected to further grow in the future. As compared with mass media, this market is about to establish the position of the third media after TV and newspapers.

Such advertisements include banner advertisements, listing advertisements and electronic mail advertisements. Among them, the banner advertisement allows a user to jump to the home page, products, etc. of an advertiser (e.g., an enterprise) by clicking a banner composed of still images, animation, etc. that are listed on the home page. The listing advertisement shows a display at a place that catches a searcher's eyes based on the search result of a famous search engine. In the electronic mail advertisement, a character text or an html file is transmitted to a subscriber of an article information delivery service. In all of those advertisements, a user can jump to the home page of an advertiser (e.g., an enterprise) by clicking an advertisement portion (See, e.g., Patent Literature 1 (Japanese Patent Application Kokai No. 2002-297993)).

However, the abovementioned conventional Internet advertisements are limited to jumping to the home page of an advertiser (e.g., an enterprise) and the pop-up capability of starting another window, and only a users action enables to move to a site of the advertiser (e.g., an enterprise) and completes the purpose. Accordingly, the advertiser needs to make various efforts in order to reach the target class of an advertisement including the installation of a banner advertisement on a large number of sites, association with searched words (the abovementioned listing advertisement) and the collection of electronic mail addresses of demand classes.

Accordingly, there has been proposed a push-type advertisement in order to achieve an advertisement effect more aggressively. A push-type advertisement is delivered at the same time that a user downloads advertisement data from the web using dedicated software. To take just an example, Patent Literature 2 (Japanese Patent Application Kokai Publication No. 2001-118006) discloses technology capable of making a user focus on an advertisement and thereby enhancing an advertisement effect by displaying advertising information on the full-screen or part of the web browser without designating any advertisement area on the home page.

Moreover, Patent Literature 3 (Japanese Patent Application Kokai Publication No. 1999-134353) discloses technology capable of delivering an advertisement to a user in accordance with the degree of coincidence between the field in which the frequency of usage by users is high and the field to which the advertisement belongs so that large pieces of information are delivered to a user who is expected to be highly interested in the advertisement while small pieces of information is delivered to a user who is less likely expected to be interested in the advertisement. Such a system is exemplified by the AdWords system provided by Google, Inc., and there have also been proposed other methods described in Patent Literature 4 (Japanese Patent Application Kokai Publication No. 1999-134353), Patent Literature 5 (Japanese Patent Application Kohyo Publication No. 2006-500700), etc.

Patent Literature 6 (U.S. Pat. No. 3,693,938) proposes a screen saver-like advertisement method using video delivery. However, this is limited to real-time retrieving and displaying as is described in its Claim 1, for example, as follows: “An information delivery system, wherein . . . delivered information is automatically retrieved and displayed, and wherein when the browser finishes the display of the contents, the information receiving program is also brought to an end.” Moreover, the first section of Claim 1 describes “the contents containing an information receiving program or a tag for an information receiving program is delivered to the computer terminal in accordance with an access from the computer terminal,” and therefore, in this patent, “the contents containing an information receiving program or a tag for an information receiving program” must be “delivered” whenever there is an access.

### SUMMARY OF THE INVENTION

### Problems That the Invention is to Solve

Thus, under the circumstances that internet utilization time has significantly increased in the daily living hours and that the utilization of cellular phones and personal computers have been changing substantially to the same meaning of using the Internet, technological elements and combinations of existing technologies are not necessarily the best though the web having interactive characteristics has been used as a media. The present invention can widely be used as internet advertisements and provides an effective and high-quality advertisement information display system that adapts to internet users' lifestyle.

Particularly, the conventional system cannot induce an Internet user to continue browsing an advertisement, and therefore the problem is that efficiency is poor for both advertisers and internet users.

### Means of Solving the Problems

As a result of intensive studies in order to solve the abovementioned problems, the present inventors found that various applications for devices including the Internet browser provided with the capability of acquiring interest keywords (those keywords are made from location information, hobbies and tastes by a unique method) of an internet connecting device itself and displaying a video, etc. in connection with the keywords are effective as an advertising means in the media and thereby completed the present invention. Moreover, further ubiquitous transmission of information is made possible by socializing a device in which an application is installed that can extract data used for analyzing the abovementioned interest keywords or those interest keywords themselves. Moreover, the present invention induces internet users to keep browsing an advertisement by incorporating a means of giving points when the advertisement is browsed so that an advertisement specialized for both advertisers and purchasers can be delivered, and thereby efficiency can markedly be increased.

In the present invention, ad marketplaces such as Yahoo, Inc. (Overture) and AdWords have been known for the advertising space evaluation, account management and charging system. This is basically a system in which the link of an advertiser who has bid a high unit price is displayed at a superior position. On the other hand, the present invention adopts a system (business model) in which a video of an advertiser who has bid a high unit price is basically delivered to a target user more preferentially, and at the same time the target user receives partial redistribution of the advertising cost set by the advertiser, and therefore this is a business model obviously different from the text advertisement including linking and clicking in terms of submission methods, advertising sizes and files, etc. In other words, the present invention also considers the fact that the delivery of videos (CM, etc.) having loads by far more than those of conventional internet advertisements including text advertisements can be realized as a business model only by combining the redistribution of profits to users.

In other words, ad marketplaces attract users by making search services free of charge, yet in this case advertisements are displayed only statically. On the other hand, the present invention goes beyond the frame of free of charge (utilization of browsers free of charge) and induces uses to video delivery advertisements by “redistributing” profits. The present invention has users accept video delivery advertisements that require time and spaces by going beyond so-called “free.”

It is possible when a comparison is made between the current TV/internet advertisement and circulation costs and estimated TV/internet viewing hours per user, or rather the present invention is an indispensable invention that enables to keep in the future the systems of top media/TV advertisements (CM, etc.) that have the tendency of declining.

Conventionally, advertisements can be displayed by html files, flash, etc. at the time of browsing a specific site on the Internet browser. Moreover, there also exist video sites using streaming technology. In these methods, however, the browser itself is not provided with the capability of acquiring and displaying video advertisement data though an advertisement can be displayed on the browser. The present invention gives the abovementioned capability to the browser itself and, therefore, is based on a totally unconventional approach.

In other words, the present invention includes aspects as shown below.
[1] A user interface, comprising in itself the capability of acquiring and displaying video advertisement data.
[2] The user interface according to Claim 1, wherein the user interface adds the advertisement acquisition capability and/or the advertisement display capability to an internet browser program that is a platform.
[3] The user interface described in the abovementioned 1 or 2, further comprising a social capability.
[4] The user interface described in any one of the abovementioned 1-3, the user interface further having an advertisement management capability, wherein the advertisement management capability maintains and/or analyzes a user's browsing history and/or retrieving history, selects a recommendable advertisement in accordance with the result and then transmits it to an advertisement acquisition capability, wherein the advertisement acquisition capability acquires advertisement data from a web server in accordance therewith, and an advertisement display capability presents an advertisement acquired by the advertisement acquisition capability on an advertisement display area provided on a part of the screen or displays it on the full screen.
[5] The user interface described in any one of the abovementioned 1-3, the user interface maintaining and/or analyzing browsing history and/or retrieving history, selecting a recommendable advertisement in accordance with the result, and presenting it on an advertisement display area provided on a part of the screen or displaying it on the full screen from a web server provided with an advertisement management capability of transmitting it to the user interface with or without going through the advertisement acquisition capability.
[6] An advertisement system, comprising at least one advertisement data storage site located on a communication network and a user terminal connected to the abovementioned communication network and provided with the user interface according to Claim 1, and by means of the advertisement display capability, displaying data acquired by the abovementioned user interface to a user in accordance with the abovementioned advertisement management capability.

[7] The advertisement system described in the abovementioned 6, wherein the advertisement data storage site has an advertisement data management file group containing advertisement files that describe the attributes of advertisements to be displayed and advertisement information database containing advertisement information to be actually displayed and transmits an advertisement in which a user may likely be interested to the abovementioned browser based on data transmitted from the advertisement acquisition capability of the abovementioned browser.
[8] The advertisement system described in the abovementioned 6 or 7, wherein advertisement videos and images at the advertisement storage site are downloaded to and stored in the storage device of a user's terminal and reproduced at the request of the user interface made for (a control unit including) the storage device.
[9] The advertisement system described in any one of the abovementioned 6-8, wherein the advertisement system further has at least one management site located on a communication network, and wherein the advertisement management capability of the abovementioned user interface maintains and/or analyzes a users advertisement browsing data and transmits the data or analyzed results to the management site, and the user gains advertisement browsing rewards in accordance therewith.
[10] The advertisement system described in any one of the abovementioned 6-8, wherein the advertisement system further has at least one management site located on a communication network, and wherein the management site maintains and/or analyzes the browsing history and/or retrieving history of each user, selects an recommendable advertisement in accordance with the result, transmits it to the user interface, and grants advertisement browsing rewards to the user.
[11] The advertisement system described in any one of the abovementioned 6-10, wherein advertisement browsing rewards are associated with the proximity between the profiles of the target class of an advertisement and the profiles of a user.
[12] The advertisement system described in any one of the abovementioned 6-11, wherein an advertisement space is purchased by an advertisement providers bidding.

When the present invention is viewed from the advertisers' side, advertisement spaces can be bid in the form of interest keywords (those keywords are made from location information, hobbies and tastes by a unique method), unlike conventional methods, for user interfaces, i.e., all the devices that can be connected to the Internet, and both the video space and the click space can be bid, and thereby a new advertisement market share can be carved out by involving the entire Internet users just as in the case of success by the “search engine-linked keyword bidding market” of Google AdWords, Overture, Inc., etc. that are currently the mainstream of Internet advertisements or in the different form. When the present invention is viewed from the users' side, there is increased possibility that needed product information can be accessed with more ease, and some users may receive the redistribution of profits as a result of browsing advertisements. Moreover, while the present invention comprises the capability of determining an advertisement to be presented to a user based on keywords searched by utilizing a request from a user interface or clicked keywords, the user interface itself can store browsing history, etc., unlike the existing browsers, without using cookies created by browsed sites (provided, the present invention does not exclude the use of this method, however), and thereby browsing can be achieved with high security.

Moreover, TV is still delivering contents with high perfection levels that cannot be matched by the Internet even at present, and superior advertisements created by professionals has also been presented. The present invention enables to equalize personal computers to TV by positioning them as so-called “communication-oriented monitors.” In other words, the business model according to the present invention enables TV commercials having excellent contents to advance to the internet world together with targeting via the monitors of personal computers in the contemporary lifestyle that requires bilateral capabilities and in which models targeting “average users” are meaningless.

### BRIEF EXPLANATION OF DRAWINGS

FIG. 1 is a schematic view showing one example of display screens according to the user interface of the present invention.

FIG. 2 is a schematic view showing the flow of information in the advertisement system according to one embodiment of the present invention.

FIG. 3 is a schematic view showing the flow of information in the advertisement system according to another embodiment of the present invention.

### MODE FOR IMPLEMENTING THE INVENTION

Next, a description of embodiments according to the present invention is given below in detail. In the drawings, reference numerals show as follows: 1, display screen of a display; 2, display area of a user interface or browser; 3, advertisement display area; 4, video display area; and 5, image display area.

### Embodiment 1

According to the first embodiment of the present invention, the user interface is run on personal computers and/or various types of dedicated terminals (including cellular phones, smart phones and various types of digital signage devices) and has an advertisement acquisition capability and an advertisement display capability in addition to ordinary user interface capabilities. In the present invention, the user interface indicates visual means that provide information and/or capability operation means on a wide variety of platforms, as described above, and has a capability approximately equal to that of the Internet browser in PC, while it may be the internet browser and applications in cellular phones and smart phones, and it includes built-in display software in digital signage devices. Next, a description of the present invention is given below using the internet browser in a representative PC as a typical example, yet the operation of applications is also considered here in the case of cellular phones and smart phones. Moreover, action of a user is not necessarily required in digital signage devices.

The basic configuration of the user interface may be the same as that of the well-known conventional configuration except for the abovementioned points, and, for example, Chromium may be used for its base portion. That is the base portion of the browser “Google Chrome” developed by Google, and the BSD license has been applied to the source code. Since WebKit is used for the Html rendering engine just as in the case of Safari, display in compliance with the web standard is possible. Besides, the present invention is applicable to both the other existing browsers and any browsers that will be developed in the future.

The advertisement acquisition capability is basically a capability of acquiring advertisement data from a preset web server, and at a predetermined timing or at a time when a user is using the Internet, acquires advertisement data based on data stored in an advertisement management capability as described below. Advertisement data is generally acquired by a wide variety of methods that are used for acquiring information from specific web sites. Typically, the acquisition of html files and the acquisition of video data are included, and the latter may be acquired by either streaming or downloading. Protocols, controls and scripts used in those methods are not only those used in existing methods but also those that may be available in browsing the web in the future. Moreover, in the present invention, video advertisements are not limited to those delivered by streaming but include aspects in which advertisements are downloaded and then reproduced for each prescribed period. In this case, also included is a pattern of downloading/updating a needed video file on the personal computer side via the internet access at the time of activating the user interface or periodically and then displaying it therefrom (this pattern is described in detail in Embodiment 2).

Additionally, the advertisement acquisition capability may also be provided with a line speed measurement capability and a browsing limitation capability, for example. To take just one example, by requesting an advertisement storage site to transmit a file having a prescribed size to a user terminal and measuring an amount of time required, the communication speed of a communication line to which the user terminal has been connected is measured. A deliverable file size is determined in accordance with the speed of the communication line, and in accordance with this determination, prescribed advertisement data (e.g., a video file) is acquired from the advertisement data storage site via the communication line and an appropriate interface. The browsing limitation capability is used for restricting the advertisements of adult sites, for example, by a user's setting, for example, or restricting the use of the present user interface on a personal computer within an enterprise. Such filtering capabilities include not only existing methods but those that will be available in browsing the web in the future.

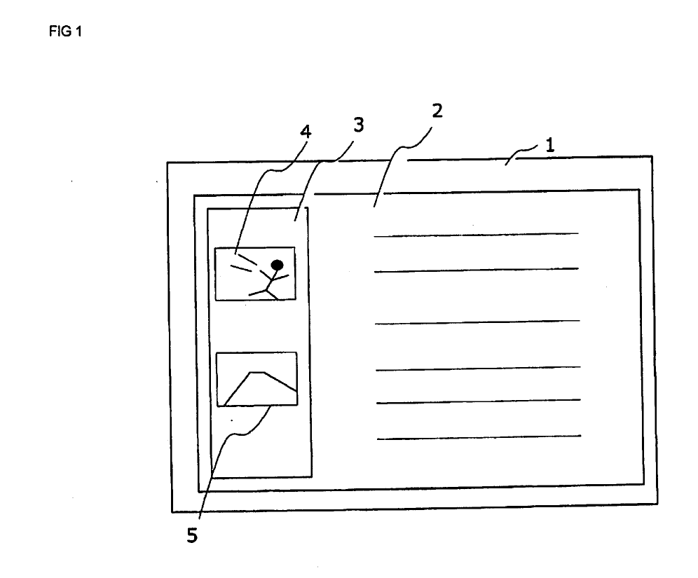

The advertisement display capability is basically a capability of displaying advertisement data acquired by the advertisement acquisition capability, is not particularly limited as far as an advertisement can be transmitted to a user, and, for example, displays at least one advertisement on an advertisement display area provided along any one of upper, lower, left and right sides on a browsing page as shown in FIG. 1. Advertisements to be displayed include video advertisements, image advertisements and text advertisements yet are basically displayed centering on video advertisements so that a capability similar to that of TV that delivers video advertisements can be realized within the capability of the user interface and particularly within the capability of the internet browser.

The advertisement area can be switched between display and non-display by a user's selection. The percentage of an advertisement area on the entire screen may be optionally settable or fixed. As far as an advertisement within an advertisement area is concerned, it is important not only to assure its visibility but to take into consideration that the browsing of a browsing page should not visually be blocked as well, and therefore video advertisements usually have 1 to 2 frames and occupy about 10 to 40% and preferably about 15 to 25% of the advertisement display area. For similar reasons, image advertisements have about 1 to 3 frames and occupy about 5 to 60% and preferably about 10 to 40% of the advertisement display area. The percentage of text advertisements is not particularly limited. The abovementioned numerical values are rough standards, and therefore other ranges are also included in the present invention.

When a browsing page can be scrolled vertically or horizontally, an advertisement display area may be moved in accordance therewith (the contents of advertisements are fixed), or different advertisements may be displayed in accordance with the scrolling. In general, it is preferred that an advertisement display area should not be overlapped with a browsing page, yet when it is expected that a user allows it, float display may be used on an area of the browsing page (i.e., such an aspect is also included in the scope of the present invention). Display may automatically be performed, or recommended ranking is shown, and display is performed up to a given ranking by a user's selection.

A user may link to the web site of an advertiser from each advertisement. More specifically, a user can jump to a preset site by clicking, tapping on the screen or operating a key, a button, or the like provided outside a display. Alternatively, an advertisement may be changed to another advertisement of the same advertiser by each clicking or changed to an advertisement of another advertiser. The timing of changing advertisements may be limited to a time when a page is transitioned, or advertisements may be changed after a prescribed period.

Movements such as clicking are recorded by an advertisement management capability as described below, and thereby specified points or money can be granted.

The advertisement display capability may be a full-screen display capability. For example, just as in the case of the existing screen saver, when a prescribed time has passed with no input from the input part (e.g., keyboard, mouse and touch panel) of a computer or the like, a video advertisement or slide advertisement is displayed. This can be switched between full-screen display and display suspension at appropriate timing by a user's operation.

As a typical display pattern, a notice that an advertisement tailored to a user has arrived is displayed in accordance with the user's activity history and advertisement presentation conditions, and when it is clicked, the advertisement display capability of the user interface according to the present invention (it may be the user interface itself instead or only the advertisement display capability (a software monitor for viewing a video)) is started to deliver a video advertisement on the full screen. When the advertisement is finished, a link button capable of linking the user to an advertiser's site or the like, which contains the determination of point granting as described below, appears. Points are added when the button is pushed, and then the page is transitioned to the page of the advertiser, for example. Alternatively, the page may be transitioned to the page of the advertiser by clicking, tapping on the screen or operating a key, a button, or the like provided outside a display while the advertisement has been displayed on the user interface.

Whether it is the display on an advertisement display area or the full-screen display, it is preferable to provide a button for making the transition to a page that displays detailed information, a button for making the transition to a purchase page and a closing button (which makes this advertisement screen come to an end immediately after clicking the screen).

The display form by the advertisement display area and the display form by the full-screen display may be switched to each other according to a user's utility form. For example, when it is determined that a user is actively browsing based on the user's activity of inputting information into a personal computer, the display form by the advertisement display area is used, while the full-screen display is used as a screen saver when there is no input or the like for a prescribed period. As for the display of videos, a capability unique to the user interface may be provided, or any existing video display method may be used. Browser plugins or applications made by third parties (e.g., JavaScript, Flash and application software described by Java®) may be actuated.

The categorization methods for display advertisements include methods tailored to users in which data based on the utility status of browsers is used as found in the prior art (as described below).

The advertisement management capability basically comprises at least one of the capability of recording users' browsing activity and/or retrieving history and/or analyzing the results, the capability of urging the advertisement acquisition capability to acquire necessary advertisement data based on the abovementioned data, the capability of storing necessary advertisement data, and the capability of storing necessary data in the case of giving users an incentive to browse advertisements. The advertisement management capability may be provided on a web server, or the browser may be provided with it in whole or in part.

The capability of recording or analyzing users' browsing activity and/or retrieving history records the history of a users browsing sites and/or retrieving contents and analyzes the tastes of the user. In the present invention, this capability can be used only by the advertisement management capability on the browser or the web, and thereby security risks and risks of individual information leaks can be minimized. It is preferred that the level of the capability of recording or analyzing users' browsing activity and/or retrieving history be adjusted by users' preference, and as described above, the analyzing capability may be provided for a web site in which advertisement data is stored. In this case, the advertisement management capability may, for example, encrypt records on the history of a users browsing sites and transmit it to a management site such as a web site in which the advertisement data is stored. When it is used in an instrument provided with localization information such as the GPS capability, positional information is preferably transmitted. On a personal computer and the like as well, it is preferred that positional information be able to be acquired when a communication provider used by a user or the user himself/herself asks.

As the configuration of the browser according to the present invention, it is preferred that a portion mainly in charge of the capability of recording or analyzing users' browsing activity and/or retrieving history be independent of the internet browsing capability and have a proxy server-like capability. In other words, when a user browses the Internet using browsers other than the user interface according to the present invention after installing the browser of the present invention, the abovementioned portion also obtains queries of browsers other than the browser of the present invention such as IE, Firefox and Chrome and transmits them to the management site (it goes without saying that this can be restricted by the user's setting). Although this type of capability is not usually the capability of the browser itself, the user interface according to the present invention includes such a capability in the advertisement management capability.

Such a configuration has the following effects. In other words, search engines of Google, etc. matches search contents with an advertisement to be presented for each search by a query within a search engine site, and therefore matching power is weak. Although efforts have been made for increasing matching power by means of retargeting even after leaving from the search engine, it is difficult to specify a user and perform optimum matching because the IP address of the connection source usually changes.

On the other hand, in the abovementioned configuration according to the present invention, a users queries are acquired together with other internet browsers, and therefore it is surely equivalent to obtaining OS queries. Accordingly, the users browsing activity is understood well, and thereby it is possible to perform advertisement matching well suited to the user with more certainty.

The capability of recording or analyzing users' browsing activity and/or retrieving history may work real time. To take just one example, in an aspect in which an advertisement display area is provided on one side of a user's browsing screen, in accordance with an element extracted from the browsing contents (e.g., the theme “automobile” when an article about automobiles has been displayed on the browsing screen), it directs the advertisement acquisition capability to acquire advertisements in accordance with the theme “automobile,” and the advertisement acquisition capability acquires necessary advertisement data from the web site (in which the advertisement data has been stored) and then displays it. In this case, if attribute information of the user such as age and gender is available, such attribute information is also used for an analysis.

The capability of storing necessary advertisement data is literally a capability of storing advertisement data acquired in accordance with a user's browsing activity. By this capability, for example, the same advertisement is presented to the user for a prescribed number of times without unnecessarily increasing traffic. Such advertisement data may be downloaded for each prescribed period or when a personal computer or other user terminal is not used for other work.

In the present invention, it is preferable to give an incentive to browse advertisements. Such incentive management is digitized by the number of times an advertisement is clicked, an advertisement displaying period, etc. and is actualized by the capability of transmitting it to a site of managing incentives at a prescribed timing. Incentives may be so-called points that can be used at the time of purchasing specific products or paying actual currency such as cash. Alternatively, it may be redistributed as provider's fees or line fees. In the conventional video, there exists no such incentives constantly, and therefore no advertisement can be delivered to a user in accordance with the user's attributes. In the present invention, since a user has a strong incentive to browse video advertisements, the user will browse video advertisement constantly. As a result, not only are advertising effects enhanced, but also users' profiles can be refined such that sales by the below-mentioned method for bidding advertisement spaces are made possible.

Since users always use the user interface, the user interface according to the present invention is preferably provided with a social capability. As used herein, the term “social capability” refers to the capability on the whole of connecting to other network users real time and includes, for example, all of the capabilities currently known as social network services in whole or in part. For example, communication systems among users in the blog, tweet, platform capabilities in social applications, etc. are included. By integrating such capabilities into the browser, users can use those capabilities without distinguishing them from the use of the user interface and the browsing of advertisements. More specifically, a tweet button, a social application button, etc. are provided in the screen configuration, and thereby users can use these capabilities seamlessly together with the user interface.

A system for giving an incentive to popularize the user interface according to the present invention may be provided in conjunction with the social capability. For example, a user's acquaintance list is extracted in the social capability, and the below-mentioned points are given when the user introduces those subscribers.

The information analysis is not limited to UI, and the present invention also includes an aspect in which UI transmits positional information, user-related information (e.g., data on hobbies, tastes and browsing history), etc.; an analysis is carried out at a site connected therewith on the Internet and corresponding advertisement data is transmitted.

### Embodiment 2

The second embodiment according to the present invention provides an advertisement system using the user interface described in Embodiment 1.

This system comprises 1) at least one advertisement data storage site located on a communication network and 2) the user interface described in Embodiment 1 (e.g., a user terminal provided with the browser) that is connected to the abovementioned communication network, wherein data acquired by the advertisement acquisition capability of the abovementioned user interface is displayed to a user by the abovementioned advertisement display capability in accordance with the abovementioned advertisement management capability.

The configuration of the advertisement data storage site is not particularly limited as far as it can commonly be used and typically includes an advertisement data management file group containing advertisement files in which the attributes (e.g., keywords and tags) to be displayed are described and a site or a site group having advertisement information database containing advertisement information to be actually displayed, wherein the site is usually constituted of a plurality of servers. The abovementioned advertisement acquisition capability of the user interface transmits user information such as a keyword (interest keyword) in which a user is expectedly interested to the advertisement data storage site based on data about the user's browsing activity and/or retrieving history and then acquires advertisements that match the keyword. The user information preferably includes information about a user's current location. Although it can be analyzed at the user interface according to the present invention, an interest keyword may be analyzed in more detail at the abovementioned site or another site that is connected via a communication line. The method of such an analysis is not particularly limited and includes the following method, for example.

The left side (function S) in the following equation shows the degree of interest in a keyword Xj by a user Ui (upper-case letters are used in place of lower-case letters u and x in the description of the equation for convenience's sake).

$$S ( {u}_{i} , {x}_{j} ) = C \times F ( {u}_{i} , {x}_{j} ) + {\sum }_{k} ( R ( {u}_{i} , {u}_{k} ) \times F ( {u}_{k} , {x}_{j} ) ) \qquad [ Mathematical Equation 1 ]$$

(wherein: Ui is the user; Xj is the keyword; C on the right side is a constant; function F is the number of times the user Ui searched the keyword Xj in the past). In a simple equation, the first term on the right side is enough, yet the second term is preferably added. This is the addition of “the number of times the user Uk searched the keyword Xj in the past' weighted by the degree of similarity in browsing activities between the user Ui and another user Uk for all the other users (the range is limited in actuality).

Here, the degree of similarity R is defined by the following equation, for example.

$$R ( {u}_{i} , {u}_{k} ) = {\sum }_{k} ( G ( {u}_{i} , {y}_{n} ) \times G ( {u}_{k} , {y}_{n} ) ) / {\sum }_{m} G ( {u}_{m} , {y}_{n} ) \qquad [ Mathematical Equation 2 ]$$

Here, the degree of similarity R is defined by the following equation, for example. Yn is the web page (the lower-case letter y is represented by an upper-case letter in the description of the equation for convenience's sake), and the function G (Ui, Yn) is the number of times the user Ui browsed the web page Yn. Addition is performed for n, which is all the possible web pages, and m, which is all the possible users (the ranges are limited in actuality).

More specifically, the degree of similarity among users is calculated in advance based on browsing history according to Equation 2, and the interest score for the keyword is found by weighting the number of retrieving times by the user and the number of retrieving times by the other users with the degree of similarity and then added according to Equation 1.

As for the number of retrieving times and the number of browsing times used above, true values may be used, or values after normalization treatment (e.g., the ratio relative to a mean value of all the users) may be used.

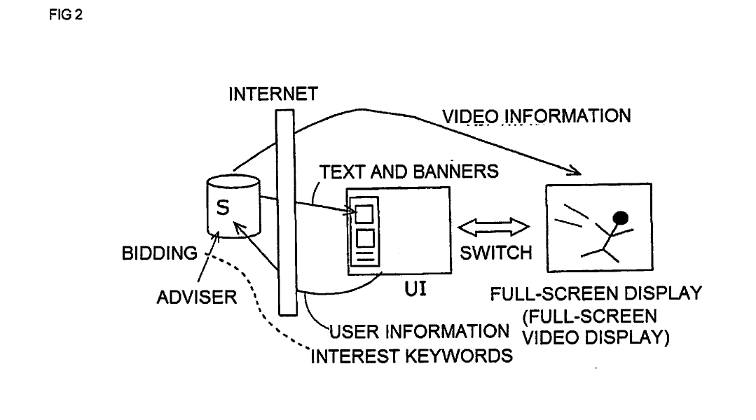

FIG. 2 shows the relationship between two display forms of the user interface (i.e., “browsing page+display of advertisement area” and “full-screen display') and a server S of the advertisement data storage site in the form slightly different from the abovementioned Embodiment 1.

In this aspect, at the time of the “browsing page+display of advertisement area,” “text and banners” advertisement data is transmitted to the user interface from the server S via the Internet, and at the time of the “full-screen display,” video advertisement data is transmitted to the user interface via the Internet. In both cases, user information is transmitted from the user interface. The switching of these displays may be operated by a user, or the former may be switched to the latter after a prescribed period elapses.

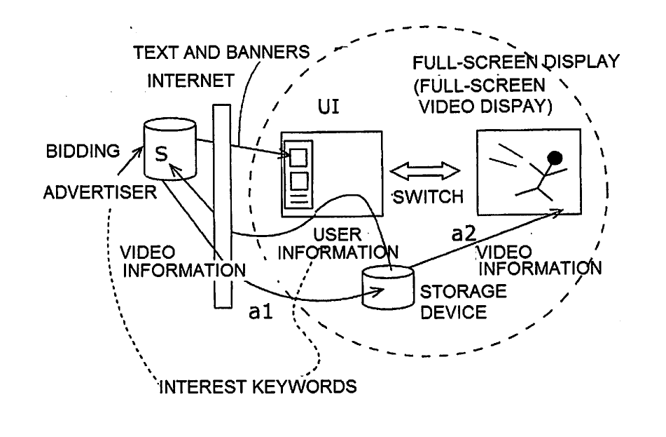

FIG. 3 shows the relationship between two display forms of the user interface (i.e., “browsing page+display of advertisement area” and “full-screen display”) and a server S of the advertisement data storage site in the form slightly different from the abovementioned Embodiment 1. In this aspect, at the time of the “browsing page+display of advertisement area,” “text and banners” advertisement data is transmitted to the user interface from the server S via the Internet, which is the same as the above, yet video advertisement data is temporarily downloaded to a user's personal computer or a storage device in a terminal from the Internet via the user interface (a1 in the drawing; a broken line in the drawing roughly shows the range of a personal computer or a user's terminal). The downloaded video information is transmitted to the user interface (a2 in the drawing) based on the “user information” from the user interface and then reproduced. The user information is transmitted to the server S from the storage device via the user interface or directly from the user interface via the Internet. Advertisement data stored in the storage device is not fixed but updated to advertisement data newly added to the server based on the user information via the Internet and the user interface. The switching of these displays may also be operated by a user, or the former may be switched to the latter after a prescribed period elapses.

Alternatively, users may be profiled using an existing profiling method and allowed to acquire an advertisement accordingly. For example, a clustering algorithm may be used in order to find a profile similar to the profile of a user. Such methods are described in various patents, articles, etc., and a method described in Japanese Patent Application Kohyo Publication No. 2003-529127 may be used for the clustering algorithm, for example.

The attributes of advertisements include display sizes, display forms and display types in addition to keywords and tags. For example, each advertisement comprises its display size (length and width of the advertisement screen), the advertisement type (text, still image, animation, etc. and particularly a video advertisement), the display timing seconds (intervals for displaying advertisements on the web browser) and advertisement information (the contents of an advertisement in accordance with the type and a period of validity), and the advertisement acquisition part of the browser can acquire advertisement information by designating the display size, display type, advertisement type, display timing seconds and keyword as acquisition request conditions whenever an advertisement needs to be acquired.

The system according to the present invention further comprises at least one management site located on a communication network and includes an advertisement system in which the abovementioned advertisement management capability of the browser stores and/or analyzes advertisement browsing data of a user and transmits the data or analytical results to the management site, and advertisement browsing rewards are given to the user accordingly. Rewards for advertisement browsing may also be decided by each clicking, browsing time, or completion of viewing.

In general, GRP refers to the gross rating point in TV advertisement and can be calculated by multiplying an audience rating by the number of times a commercial was delivered for each time zone and then adding up the results. GRP is an index frequently used as a target of advertisement delivery. In advertisements that use the Internet as in the case of the present invention, the audience rating per time zone is substantially the same as GRP, etc. and has no significant meaning for internet advertisements. Accordingly, for example, the present invention may use a reward setting method for maximizing the delivery unit price as the number of advertisers who are bidding companies increases by making advertisers bid for delivery assurance with an eye to the degree of proximity between the profile of a user and a target user profile, an advertisement browsing period and the number of browsing times.

By way of example, as to cosmetics whose target users belongs to an F1 class (females ages 20-34), the effect of an advertisement is generally low when an M3 class (males ages 50 and over) clicks the advertisement many times and browses it for a long period. Accordingly, in this example, the categorization is such that the degree of proximity to the target user profile (hereinafter referred to as the “degree of proximity” for convenience' sake) for the profile of the F1 class is set to 1, while the degree of proximity is set to a proper value less than 1 (e.g., 0.3) for the profile of the M3, and delivery is made to a class closer to 1 in the degree of proximity by means of the advertisement acquisition capability, and rewards for browsing are also correlated to the degree of proximity (in this example, points acquired by the M3 class's browsing is up to 0.3 times as much as the F1 class's browsing). Accordingly, even when a female in the F1 class and a male in the M3 class view the same advertisement for the same period, a reward to the latter is at most 0.3 times as much as a reward to the former, and thereby unnecessary advertisement rewards can be eliminated.

Advertisements thus specified for object persons are of different value to advertisement providers as well. Accordingly, in the present invention, it is preferable to have a system in which an advertisement space (the advertisement space is limitless in the present invention) is purchased by an advertisement provider by bidding. That is, the present system is a system in which purchasing costs in advertisement delivery change depending on the profile of target users. For example, an advertiser enters a bid in accordance with certain attributes of estimated object persons (e.g., gender, age, occupation, and hobbies) or keywords and can preferentially deliver an advertisement to a class that is expected to respond to those attributes (e.g., gender, age, occupation, and hobbies) or keywords. There are already systems for entering a bid for price determination by keywords such as AdWords in advertisements, yet there is no system capable of not only handling video delivering advertisements but also allowing advertisers to enter a bid by interest keywords. Video advertisements delivered in the present invention are basically those including clicking, and a bidding system having only a clicking portion is similar to PPC (Pay Per Click) systems such as AdWords, yet the present system is obviously different from conventional systems such as PPC advertisements of Overture, Inc. in that advertisement delivering ranking and the logic of determining ranking, etc. are based on values added with a unit price per second of the delivery of interest keyword-oriented videos according to the present invention and a bidding unit price of PPS (Pay Per Show), which is a delivery assurance type.

### Embodiment 3

Accordingly, the third embodiment according to the present invention provides an advertisement bidding/placing system for advertisement media using the browser described in Embodiment 1.

This system comprises 1) at least one advertisement data storage site located on a communication network and 2) an advertisement bidding/placing site connected to a part of an advertisement data storage site or an advertisement data storage site on the whole and is a system in which advertisement data is registered in the advertisement data storage site from the advertisement bidding/placing site.

This system is typically connected to the abovementioned communication network described in Embodiment 2 and works together with the system described in Embodiment 1 in which the abovementioned advertisement data acquired by the advertisement acquisition capability of the browser is displayed to a user by the abovementioned advertisement display capability in accordance with the abovementioned advertisement management capability.

An advertiser makes a connection to this system via a communication network. At an advertisement bidding/placing site, a menu screen is displayed for the advertiser who has connected. The menu screen changes one after another by the advertiser's selection, and the advertiser can input the upload of an advertisement video, a keyword, an object target, a bidding unit price, a interested delivery time zone, presence or absence of click assurance, a bidding unit price for click assurance, a linked URL to which a screen is jumped at the time of clicking, a returns rate for a click browsing user, an object platform, a total payment amount, etc. in whole or in part.

Here, the keyword is used for specifying an object target. As described above, in the advertisement system according to the present invention, a user's interest keywords are analyzed at all times, and an object target is primarily narrowed down by the selection of a keyword by an advertiser. In the advertisement system according to the present invention, it is also possible for an advertiser to aggressively select a target For example, an advertiser can use attribute keywords based on hobbies and tastes selected by directly presenting questionnaires to users such as liquor and sports (these may further be broken down to beer, white distilled liquor, wine, golf, baseball, soccer, etc.) or classification by industrial types such as eating and drinking establishments, beauty parlors and haircutting (these may further be broken down to restaurants, saloons, Japanese restaurants, noodle shops, beauty salons, nail salons, barbershops, etc.) and usually can further specify a target by combining those with local districts.

Advertisement delivery is bid for a target class narrowed down by interest keywords and/or attribute keywords, positional information, etc. The bidding unit price is typically a payment amount per advertisement display time by an advertiser, and in the advertisement system according to the present invention, it is possible to urge to increase or decrease a bidding unit price by presenting expected delivery time. More specifically, at the time of entering a bid for a keyword, it is displayed that an advertisement can currently be delivered to what type of delivery objects (a group specified by interest keywords and/or attribute keywords, positional information) and approximately to how many people. Since a bidding unit price varies among delivery objects, a bidding amount target for each delivery object must always be displayed.

At the time of bidding, the delivery order of videos to be delivered to users and ranking (if ranking is displayed) are competed. Although an interested delivery time zone is also considered, control may be performed by the system in such a manner that advertisements of the same industrial type should not be delivered to the same user many times in a day.

Typically, the delivery ranking (first [added by the translator—Tr. Note]) goes to an advertiser having a high bidding unit price, yet more effective delivery may be aimed in view of the matching ratio of a combination of keywords bid by advertisers to users' interest keywords and other elements. For example, a high weight is given to a user's present position because it is basically certain, and delivery ranking, delivery time length, etc. are decided based on the matching ratio of interest keywords in accordance with users' activities to a combination of keywords bid by advertisers and other conditions set by advertisers.

By way of example, a successful bidder and the order of priority are determined by W1×q+W2×b, wherein: supposing the number of interest keywords is p, the abovementioned function S (Ui, Xj) is calculated from X1 to Xp, and the number of pieces (q) equal to or more than a fixed value is found; and this value q is multiplied by a proper weighting constant W1, and to this, (a value found by [added by the translator—Tr. Note]) multiplying a bidding unit price (b) by a proper weighting constant W2 (is added [added by the translator—Tr. Note]). Although we used the number of pieces q above as the matching ratio of the number of interest keywords, a value found by adding up S (Ui, Xj) from X1 to Xp may be used instead as a representative value for the matching ratio, or a polynomial expression of S (Ui, Xj) may also be used, or it may be a norm in a p-dimensional space having S (Ui, Xj) as a component or any other function.

In general, the bidding unit price b is a value found by adding PPS and PPC at bidding unit prices. Although there are advertisement spaces that cannot be bid by PPS alone or by PPC alone depending on delivery destinations, the delivery ranking may well be determined using bidding prices under available conditions.

The click assurance is a method of listing an advertisement until a prescribed number of times is clicked during an contract period in an advertisement system in which a screen jumps to a linked screen as described below at a time when a viewer clicks it; the linked URL to which the screen is jumped at the time of clicking is basically an advertiser's web site or the like; and the setting may be such that rewards are added to a user who clicked and browsed it.

In the case of PPC, actual delivery time is different from initially estimated delivery time, and therefore it is preferred that a unit price be set in accordance with click time length for actual delivery time in view of the degree of advertisement delivery to a user and delivery costs. For example, supposing an average is 15 seconds, and an initially estimated delivery unit price is 0.20 yen/second/person, the unit price by second is increased if the actual delivery time is less than 15 seconds and reduced if it exceeds 15 seconds.

Object platforms include personal computers, cellular phones, smart phones and digital signage devices.

Moreover, the advertisement system according to the present invention can be combined with other video delivery sites: videos uploaded at other video delivery sites can be delivered at the user interface according to the present invention under prescribed conditions, or advertisement spaces at other video delivery sites can be bid at the advertisement system according to the present invention.

### INDUSTRIAL FIELD OF APPLICATION

To be short, the present invention enables to realize the capability of TV's delivering video advertisements within the capability of Internet browsers. In other words, the present invention provides a capability different from the capability of conventional internet browsers (i.e., the capability of connecting itself to an advertisement delivery server) in the browser-using space (by working together with the browser). Moreover, browsers according to the present invention have the social capability and are used by users constantly, and therefore a wide variety of flows of information can be received. Accordingly, user profiles can be refined through the selection of advertisements, and therefore the present invention is an extremely meaningful system as an advertisement media. Moreover, the present invention enables even medium and small-sized enterprises and stores that can afford only small amounts of investment for advertisements to deliver video advertisements by means of efficient delivery targeting including the delivery of advertisements only to specific classes after selecting interests, etc. in minute details and thereby can carve out new advertisement demands.

Furthermore, at least half of current TV commercials spend the last 2 seconds or so out of 15 seconds for “searching a keyword and an approach for allowing it to be inputted into a search window,” and an advertiser uses a TV commercial not only as branding but also as a tool for guiding a user to its own site, while the advertisement contents of the present invention show effects very similar to those of current TV commercials in that there is a portion displaying “a button that allows a user to jump to URL designated by an advertiser” on a delivered video or after delivering a video. In other words, various types of user interfaces that are objects of the present invention have the capability of allowing a user to click on a delivered video. Nevertheless, those user interfaces far exceed conventional TV commercials in that the present invention enables to provide an advertisement space that matches better than TV commercials in terms of satisfying the current needs of advertisers as described above.

We claim:

1. A user interface, comprising in itself the capability of acquiring and displaying video advertisement data.

2. The user interface according to claim 1, wherein the user interface adds the advertisement acquisition capability and/or the advertisement display capability to an Internet browser program that is a platform.

3. The user interface according to claim 1 or 2, comprising the capability of transmitting a user's location information and data on hobbies and tastes of the user to an advertisement analysis and/or management site.

4. The user interface according to any one of claims 1-3, the user interface further comprising an advertisement management capability, wherein the advertisement management capability maintains and/or analyzes a user's location information and/or data on hobbies and tastes of the user and/or the user's browsing history and/or retrieving history, selects a recommendable advertisement in accordance with the result and then transmits it to an advertisement acquisition capability, wherein the advertisement acquisition capability acquires advertisement data from a web server in accordance therewith, and an advertisement display capability presents an advertisement acquired by the advertisement acquisition capability on an advertisement display area provided on a part of the screen or displays it on the full screen.

5. The user interface according to any one of claims 1-3, the user interface maintaining and/or analyzing browsing history and/or retrieving history, selecting a recommendable advertisement in accordance with the result, and presenting it on an advertisement display area provided on a part of the screen or displaying it on the full screen from a web server provided with an advertisement management capability of transmitting it to the user interface with or without going through the advertisement acquisition capability.

6. An advertisement system, comprising at least one management site located on a communication network and a user terminal connected to the communication network and provided with the user interface according to claim 1, analyzing the user's location information and data on hobbies and tastes of the user transmitted by the user interface at the management site, and displaying it to a user by the advertisement display capability in accordance with the result

7. The advertisement system according to claim 5, wherein the advertisement data storage site comprises an advertisement data management file group comprising advertisement files that describe the attributes of advertisements to be displayed and advertisement information database comprising advertisement information to be actually displayed and transmits an advertisement in which a user may likely be interested to the browser based on data transmitted from the advertisement acquisition capability of the browser.

8. The advertisement system according to claim 6 or 7, wherein advertisement videos and images at the advertisement storage site are downloaded to and stored in the storage device of a user's terminal and reproduced at the request of the user interface made for (a control unit including) the storage device.

9. The advertisement system according to any one of claims 6-8, further comprising at least one management site located on a communication network, wherein the advertisement management capability of the browser maintains and/or analyzes a user's advertisement browsing data and transmits the data or analyzed results to the management site, and the user gains advertisement browsing rewards in accordance therewith.

10. The advertisement system according to any one of claims 6-8, further comprising at least one management site located on a communication network, wherein the management site maintains and/or analyzes the browsing history and/or retrieving history of each user, selects an recommendable advertisement in accordance with the result, transmits it to the user interface, and grants advertisement browsing rewards to the user.

11. The advertisement system according to any one of claims 6-10, wherein advertisement browsing rewards are associated with the proximity between the profiles of the target class of an advertisement and the profiles of a user.

12. The advertisement system according to any one of claims 6-11, wherein an advertisement space is purchased by an advertisement provider's bidding.
